(19) United States
(12) Patent Application Publication
(10) Pub. No.: US 2012/0129268 A1
(43) Pub. Date: May 24, 2012

(54) PHOTOLUMINESCENT OXYGEN PROBE WITH REDUCED CROSS-SENSITIVITY TO HUMIDITY

(76) Inventor: Daniel W. Mayer, Wyoming, MN (US)

(21) Appl. No.: 12/950,027

(22) Filed: Nov. 19, 2010

(51) Int. Cl. G01N 21/63; B32B 37/02; B05D 5/06

(52) U.S. Cl. 436/138; 422/86; 427/162; 156/60

(57) ABSTRACT

An oxygen-sensitive luminescent element, and probe constructed therefrom, having reduced cross-sensitivity to humidity, and methods of manufacturing and using such luminescent elements and probes to measure oxygen concentrations within an enclosed space. The luminescent element includes a glass fiber carrier substrate bearing an oxygen-sensitive photoluminescent dye. The dye is preferably embedded within an oxygen-permeable hydrophobic polymer matrix. A probe is constructed from the luminescent element by laminating the luminescent element onto a structural support layer.

### BACKGROUND

Solid-state polymeric materials based on oxygen-sensitive photoluminescent dyes are widely used as optical oxygen sensors and probes. See, for example United States Published Patent Applications 2009/0029402, 2008/8242870, 2008/215254, 2008/199360, 2008/190172, 2008/148817, 2008/146460, 2008/117418, 2008/0051646, 2006/0002822, U.S. Pat. Nos. 7,569,395, 7,534,615, 7,368,153, 7,138,270, 6,689,438, 5,718,842, 4,810,655, and 4,476,870. Such optical sensors are available from a number of suppliers, including Presens Precision Sensing, GmbH of Regensburg, Germany, Oxysense of Dallas, Tex., United States, and Luxcel Biosciences, Ltd of Cork, Ireland.

To increase photoluminescent signals obtainable from the sensor and thus increase the reliability of optical measurements, oxygen-sensitive materials often incorporate a light-scattering additive (e.g., TiO2—Klimant I., Wolfbeis O. S.—Anal Chem, 1995, v. 67, p. 3160-3166) or underlayer (e.g., microporous support—see Papkovsky, D B et al.—Sensors Actuators B, 1998, v. 51, p. 137-145). Unfortunately, such probes tend to show significant cross-sensitivity to humidity, preventing them from gaining wide acceptance for use in situations where humidity of the samples under investigation cannot be controlled.

Hence, a need exists for an optical photoluminescent oxygen probe with reduced cross-sensitivity to humidity.

### SUMMARY OF THE INVENTION

A first aspect of the invention is a luminescent element comprising a glass fiber carrier substrate bearing an oxygen-sensitive photoluminescent dye. The oxygen-sensitive photoluminescent dye is preferably embedded within an oxygen-permeable hydrophobic polymer matrix.

A second aspect of the invention is an oxygen-sensitive probe comprising the luminescent element of the first aspect laminated onto a structural support layer. The luminescent element is preferably laminated to the structural support layer as a solid state composition, wherein the solid state composition comprises the oxygen-sensitive photoluminescent dye embedded within an oxygen-permeable hydrophobic polymer matrix.

A third aspect of the invention is a method for measuring oxygen concentration within an enclosed space employing an oxygen-sensitive probe according to the second aspect of the invention. The method includes the steps of (A) obtaining an oxygen-sensitive probe according to the second aspect of the invention, (B) placing the probe within the enclosed space, and (C) ascertaining oxygen concentration within the enclosed space by (i) repeatedly exposing the probe to excitation radiation over time, (ii) measuring radiation emitted by the excited probe after at least some of the exposures, (iii) measuring passage of time during the repeated excitation exposures and emission measurements, and (iv) converting at least some of the measured emissions to an oxygen concentration based upon a known conversion algorithm.

A fourth aspect of the invention is a method for monitoring changes in oxygen concentration within an enclosed space employing an oxygen-sensitive probe according to the second aspect of the invention. The method includes the steps of (A) obtaining an oxygen-sensitive probe according to the second aspect of the invention, (B) placing the probe within the enclosed space, (C) ascertaining oxygen concentration within the enclosed space over time by (i) repeatedly exposing the probe to excitation radiation over time, (ii) measuring radiation emitted by the excited probe after at least some of the exposures, (iii) measuring passage of time during the repeated excitation exposures and emission measurements, and (iv) converting at least some of the measured emissions to an oxygen concentration based upon a known conversion algorithm, and (D) reporting at least one of (i) at least two ascertained oxygen concentrations and the time interval between those reported concentrations, and (ii) a rate of change in oxygen concentration within the enclosed space calculated from data obtained in step (C).

A fifth aspect of the invention is a method of preparing a luminescent element according to the first aspect of the invention. The method includes the steps of (A) preparing a coating cocktail which contains the photoluminescent oxygen-sensitive dye and the oxygen-permeable polymer in an organic solvent, (B) applying the cocktail to a first major surface of the glass fiber carrier substrate, and (C) allowing the cocktail to dry, whereby a solid-state thin film coating is formed on the glass fiber carrier substrate to form the luminescent element.

A sixth aspect of the invention is a method of preparing a photoluminescent oxygen-sensitive probe according to the second aspect of the invention. The method includes the steps of (A) preparing a luminescent element in accordance with the fifth aspect of the invention, and, (B) laminating the luminescent element onto the first major surface of a structural support layer.

### BRIEF DESCRIPTION OF THE DRAWINGS

FIG. 1 is an enlarged top view of one embodiment of the invention.

FIG. 2 is a side view of invention depicted in FIG. 1.

FIG. 2A is an enlarged side view of a central portion of the invention depicted in FIG. 2.

FIG. 2B is a microscopically enlarged side view of the luminescent component of the invention depicted in FIG. 2.

FIG. 2C is a cross-sectional view of one fibril depicted in FIG. 2B.

### DETAILED DESCRIPTION OF A PREFERRED EMBODIMENT

### Definitions

As used herein, including the claims, the phrase “near 100% relative humidity” means humidity as close as reasonably possible to 100% without condensation.

As used herein, including the claims, the phrase “oxygen permeable” means a material that when formed into a 1 mil film has an oxygen transmission rate of greater than 1,000 c³/m2 day when measured in accordance with ASTM D 3985.

### NOMENCLATURE

10 Oxygen Sensitive Probe
20 Luminescent Element
21 Oxygen-Sensitive Photoluminescent Dye
22 Oxygen-Permeable Polymer Matrix
23 Carrier Substrate
24 Individual Fibril of Carrier Substrate
24′ Coated Individual Fibril of Carrier Substrate
30 Pressure Sensitive Adhesive Layer
40 Structural Support Layer
40a First or Upper Major Surface of Structural Support Layer
40b Second or Lower Major Surface of Structural Support Layer

### DESCRIPTION

Construction

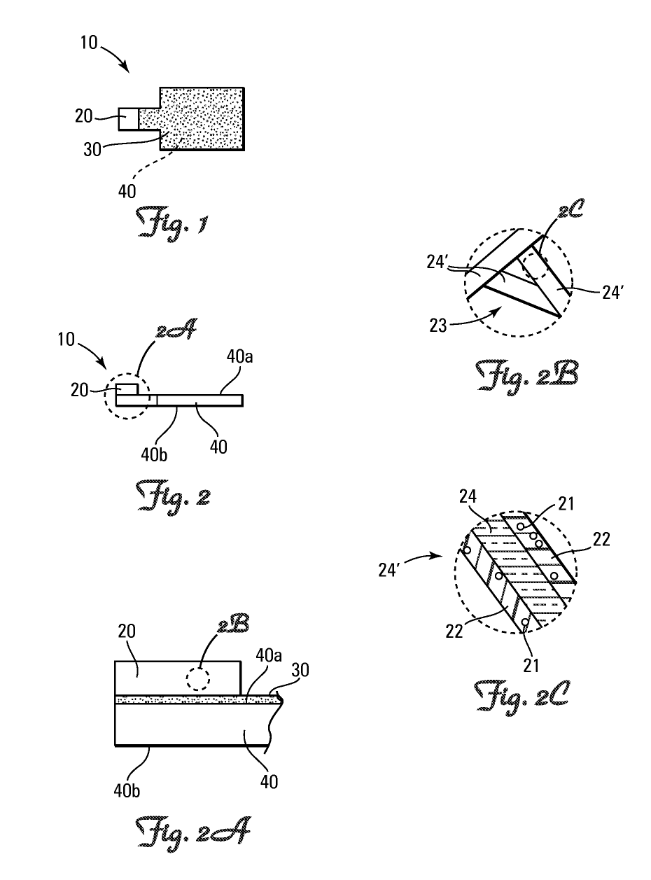

Referring generally to FIGS. 1 and 2, a first aspect of the invention is an oxygen-sensitive probe or sensor 10 useful for optically measuring oxygen concentration within an enclosed space (not shown), such as the retention chamber (not shown) of a hermetically sealed package (not shown). The probe 10 includes a luminescent element 20 laminated onto a structural support layer 40.

Referring to FIGS. 2A-2C, the luminescent element 20 includes a glass fiber carrier substrate 23 bearing an oxygen-sensitive photoluminescent dye 21. The oxygen-sensitive photoluminescent dye 21 is preferably embedded within an oxygen-permeable polymer matrix 22. Referring to FIG. 2C, but without intending to be unduly limited thereby, it is believed that the compounded photoluminescent dye 21 and oxygen-permeable polymer matrix 22 penetrate into the interstitial void volume of the glass fiber carrier substrate 23 and coat the individual fibrils 24 of the carrier substrate 23 to form coated fibrils 24′.

The oxygen-sensitive photoluminescent dye 21 may be selected from any of the well-known oxygen sensitive photoluminescent dyes 21. One of routine skill in the art is capable of selecting a suitable dye 21 based upon the intended use of the probe 10. A nonexhaustive list of suitable oxygen sensitive photoluminescent dyes 21 includes specifically, but not exclusively, ruthenium(II)-bipyridyl and ruthenium(II)-diphenylphenanothroline complexes, porphyrin-ketones such as platinum(II)-octaethylporphine-ketone, platinum(II)-porphyrin such as platinum(II)-tetrakis(pentafluorophenyl)porphine, palladium(II)-porphyrin such as palladium(II)-tetrakis(pentafluorophenyl)porphine, phosphorescent metallocomplexes of tetrabenzoporphyrins, chlorins, azaporphyrins, and long-decay luminescent complexes of iridium(III) or osmium(II).

Typically, the hydrophobic oxygen-sensitive photoluminescent dye 21 is compounded with a suitable oxygen-permeable and hydrophobic carrier matrix 22. Again, one of routine skill in the art is capable of selecting a suitable oxygen-permeable hydrophobic carrier matrix 22 based upon the intended use of the probe 10 and the selected dye 21. A nonexhaustive list of suitable polymers for use as the oxygen-permeable hydrophobic carrier matrix 22 includes specifically, but not exclusively, polystryrene, polycarbonate, polysulfone, polyvinyl chloride and some co-polymers.

The glass fiber carrier substrate 23 is a glass fiber sheet, preferably a glass fiber filter with first and second major surfaces (unnumbered). Such materials, when employed as the carrier for the oxygen-sensitive photoluminescent dye 21, substantially reduces cross-sensitivity of the luminescent element 20 to humidity relative to other probes 10. Suitable glass fiber filter discs are widely available from a number of sources including specifically, but not exclusively, Millipore Corporation of Bedford, Mass. under the designations (APFA, APFB, APFC, APFD, APFF and AP40 for binder-free filters and AP15, AP20 AP25 for binder-containing filters), Zefon International, Inc. of Oscala, Fla. (IW-AH2100, IW-A2100, IW-AE2100, IW-B2100, IW-C2100, IW-D2100, IW-E2100 and IW-F2100 for binder-free filters) and Pall Corporation of Port Washington, N.Y. (A/B, A/C A/D and A/E for binder-free filters and Metrigard™ for binder-containing filters).

The glass fiber carrier substrate 23 preferably has a thickness of between 100 μm and 5,000 μm, most preferably between 200 μm and 2,000 μm.

The structural support layer 40 may be selected from any material possessing sufficient structural integrity to physically support the luminescent element 20 and capable of withstanding extended exposure to the environment into which the probe 10 is to be used (e.g., high humidity, low humidity, submerged in water, submerged in an acidic solution, etc). Materials suitable for use as the structural support layer 40, dependent of course upon the environment into which the probe 10 is to be used, include specifically but not exclusively, cellulosics such as paper, wax paper, cardstock, cardboard, wood and wood laminates; plastics such polyethylene, polypropylene and polyethylene terephthalate; metals such as aluminum sheets, aluminum foil, steel and tin; woven and unwoven fabrics; glass; and various combinations and composites thereof such a mylar.

Referring to FIG. 2A, the probe 10 preferably includes a layer of a pressure sensitive adhesive 30 on the first major surface 40a of the structural support layer 40 for securing the luminescent element 20 onto the structural support layer 40 and facilitating attachment of the probe 10 to a surface (not shown) of a container (not shown) that defines the enclosed space (not shown) whose oxygen concentration is to be measured, with the luminescent element 20 on the probe 10 facing outward from the container (not shown) through an area of the container (not shown) that is transparent or translucent to radiation at the excitation and emission wavelengths of the dye 21 in the luminescent element 20. The adhesive 30 may but should not cover the luminescent element 20.

The probes 10 and luminescent elements 20 of the present invention have little cross-sensitivity to humidity, with a change of luminescence lifetime, at a constant O₂ concentration, of less than 5% with a change in relative humidity of an analyte gas from 0% to near 100%. Indeed, certain combinations of a particular oxygen-sensitive photoluminescent dye 21, particular oxygen-permeable hydrophobic polymer matrix 22, and particular glass fiber carrier substrate 23, a change in luminescence lifetime of less than 3% and even less than 1% can be readily achieved.

Manufacture

The luminescent element 20 can be manufactured by the traditional methods employed for manufacturing such elements 20. Briefly, the luminescent element 20 can be conveniently manufactured by (A) preparing a coating cocktail (not shown) which contains the photoluminescent oxygen-sensitive dye 21 and the oxygen-permeable polymer 22 in an organic solvent (not shown) such as ethylacetate, (B) applying the cocktail to at least the first major surface (unnumbered) of a glass fiber carrier substrate 23, such as by dunking the glass fiber carrier substrate 23 in the cocktail (not shown), and (C) allowing the cocktail (not shown) to dry, whereby a solid-state thin film coating is formed on the glass fiber carrier substrate 23 to form the luminescent element 20.

Generally, the concentration of the polymer 22 in the organic solvent (not shown) should be in the range of 0.1 to 20% w/w, with the ratio of dye 21 to polymer 22 in the range of 1:20 to 1:10,000 w/w, preferably 1:50 to 1:5,000 w/w.

The probe 10 can be manufactured from the luminescent element 20 by laminating the luminescent element 20 onto the first major surface 40a of the structural support layer 40.

The luminescent element 20 is preferably adhesively laminated to the structural support layer 40. For most applications, the layer of pressure sensitive adhesive 30 is preferably coated over the entire first major surface 40a of the support material 40 using conventional coating techniques, so that the exposed pressure sensitive adhesive 30 can be used to adhesively attach the probe 10 to a sidewall of a container (not shown) with the luminescent element 20 facing the sidewall for subsequent interrogation by a reader (not shown) through the sidewall (not shown).

Use

The probe 10 can be used to quickly, easily, accurately and reliably measure oxygen concentration within an enclosed space (not shown) regardless of the relative humidity within the enclosed space (not shown). The probe 10 can be used to measure oxygen concentration in the same manner as other oxygen sensitive photoluminescent probes. Briefly, the probe 10 is used to measure oxygen concentration within an enclosed space (not shown) by (A) placing the probe 10 within the enclosed space (not shown) at a location where radiation at the excitation and emission wavelengths of the dye 21 can be transmitted to and received from the luminescent element 20 with minimal interference and without opening or otherwise breaching the integrity of the enclosure, and (B) ascertaining the oxygen concentration within the enclosed space (not shown) by (i) repeatedly exposing the probe 10 to excitation radiation over time, (ii) measuring radiation emitted by the excited probe 10 after at least some of the exposures, (iii) measuring passage of time during the repeated excitation exposures and emission measurements, and (iv) converting at least some of the measured emissions to an oxygen concentration based upon a known conversion algorithm. Such conversion algorithms are well know to and readily developable by those with routine skill in the art.

In a similar fashion, the probe 10 can be used to quickly, easily, accurately and reliably monitor changes in oxygen concentration within an enclosed space (not shown) regardless of the relative humidity within the enclosed space (not shown). The probe 10 can be used to monitor changes in oxygen concentration in the same manner as other oxygen sensitive photoluminescent probes. Briefly, the probe 10 is used to monitor changes in oxygen concentration within an enclosed space (not shown) by (A) placing the probe 10 within the enclosed space (not shown) at a location where radiation at the excitation and emission wavelengths of the dye 21 can be transmitted to and received from the luminescent element 20 with minimal interference and without opening or otherwise breaching the integrity of the enclosure, (B) ascertaining the oxygen concentration within the enclosed space (not shown) over time by (i) repeatedly exposing the probe 10 to excitation radiation over time, (ii) measuring radiation emitted by the excited probe 10 after at least some of the exposures, (iii) measuring passage of time during the repeated excitation exposures and emission measurements, and (iv) converting at least some of the measured emissions to an oxygen concentration based upon a known conversion algorithm, and (C) reporting at least one of (i) at least two ascertained oxygen concentrations and the time interval between those reported concentrations, and (ii) a rate of change in oxygen concentration within the enclosed space calculated from data obtained in step (B). Conversion algorithms used to convert the measured emissions to an oxygen concentration are well know to and readily developable by those with routine skill in the art.

The radiation emitted by the excited probe 10 can be measured in terms of intensity and/or lifetime (rate of decay, phase shift or anisotropy), with measurement of lifetime generally preferred as a more accurate and reliable measurement technique when seeking to establish oxygen concentration via measurement of the extent to which the dye 21 has been quenched by oxygen.

I claim:

1. An oxygen sensitive luminescent element comprising a glass fiber carrier substrate bearing an oxygen-sensitive photoluminescent dye.

2. The luminescent element of claim 1 wherein the glass fiber carrier substrate is binder-free.

3. The luminescent element of claim 1 wherein the glass fiber carrier substrate contains a binder.

4. The luminescent element of claim 1 wherein the glass fiber carrier substrate is a glass fiber filter.

5. The luminescent element of claim 1 wherein the oxygen-sensitive photoluminescent dye is embedded within an oxygen-permeable hydrophobic polymer matrix.

6. The luminescent element of claim 5 wherein the oxygen-sensitive photoluminescent dye is a transition metal complex.

7. The luminescent element of claim 6 wherein the transition metal complex is selected from the group consisting of a ruthenium bipyridyl, a ruthenium diphenylphenanothroline, a platinum porphyrin, a palladium porphyrin, a phosphorescent metallocomplex of a porphyrin-ketone, an azaporphyrin, a tetrabenzoporphyrin, a chlorin, and a long-decay luminescent complex of iridium(III) or osmium(II).

8. The luminescent element of claim 7 wherein the oxygen-permeable polymer matrix is selected from the group consisting of polystryrene, polycarbonate, polysulfone, and polyvinyl chloride.

9. The luminescent element of claim 1 wherein the glass fiber carrier substrate is a sheet between 100 μm and 5,000 μm thick.

10. An oxygen-sensitive probe comprising the luminescent element of claim 1 laminated onto a structural support layer.

11. The oxygen-sensitive probe of claim 10 further comprising a layer of a pressure-sensitive adhesive on a first major surface of the structural support layer whereby the adhesive layer is sandwiched between the structural support layer and the luminescent element.

12. The oxygen-sensitive probe of claim 10 wherein the luminescent element is laminated to the structural support layer as a solid state composition, wherein the solid state composition comprises the oxygen-sensitive photoluminescent dye embedded within an oxygen-permeable hydrophobic polymer matrix.

13. The oxygen-sensitive probe of claim 10 wherein the probe has a change of luminescence lifetime of less than 5% with a change in relative humidity of an analyte gas from 0% to near 100%.

14. A method for measuring oxygen concentration within an enclosed space, comprising the steps of:
(a) obtaining an oxygen-sensitive probe according to claim 10,
(b) placing the probe within the enclosed space, and
(c) ascertaining oxygen concentration within the enclosed space by:
(i) repeatedly exposing the probe to excitation radiation over time,
(ii) measuring radiation emitted by the excited probe after at least some of the exposures,
(iii) measuring passage of time during the repeated excitation exposures and emission measurements, and
(iv) converting at least some of the measured emissions to an oxygen concentration based upon a known conversion algorithm.

15. A method for measuring oxygen concentration within an enclosed space, comprising the steps of:
(a) obtaining an oxygen-sensitive probe according to claim 12,
(b) placing the probe within the enclosed space,
(c) ascertaining oxygen concentration within the enclosed space by:
(i) repeatedly exposing the probe to excitation radiation over time,
(ii) measuring radiation emitted by the excited probe after at least some of the exposures,
(iii) measuring passage of time during the repeated excitation exposures and emission measurements, and
(iv) converting at least some of the measured emissions to an oxygen concentration based upon a known conversion algorithm.

16. The method of claim 14 wherein the enclosed space is a retention chamber of a hermetically sealed package.

17. A method for monitoring changes in oxygen concentration within an enclosed space, comprising the steps of:
(a) obtaining an oxygen-sensitive probe according to claim 10,
(b) placing the probe within the enclosed space,
(c) ascertaining oxygen concentration within the enclosed space over time by:
(i) repeatedly exposing the probe to excitation radiation over time,
(ii) measuring radiation emitted by the excited probe after at least some of the exposures,
(iii) measuring passage of time during the repeated excitation exposures and emission measurements, and
(iv) converting at least some of the measured emissions to an oxygen concentration based upon a known conversion algorithm, and
(d) reporting at least one of (i) at least two ascertained oxygen concentrations and the time interval between those reported concentrations, and (ii) a rate of change in oxygen concentration within the enclosed space calculated from data obtained in step (c).

18. A method for monitoring changes in oxygen concentration within an enclosed space, comprising the steps of:
(a) obtaining an oxygen-sensitive probe according to claim 12,
(b) placing the probe within the enclosed space,
(c) ascertaining oxygen concentration within the enclosed space over time by:
(i) repeatedly exposing the probe to excitation radiation over time,
(ii) measuring radiation emitted by the excited probe after at least some of the exposures,
(iii) measuring passage of time during the repeated excitation exposures and emission measurements, and
(iv) converting at least some of the measured emissions to an oxygen concentration based upon a known conversion algorithm, and
(d) reporting at least one of (i) at least two ascertained oxygen concentrations and the time interval between those reported concentrations, and (ii) a rate of change in oxygen concentration within the enclosed space calculated from data obtained in step (c).

19. The method of claim 17 wherein the enclosed space is a retention chamber of a hermetically sealed package.

20. A method of preparing the luminescent element of claim 5, which includes at least the steps of:
(a) preparing a coating cocktail which contains the photoluminescent oxygen-sensitive dye and the oxygen-permeable polymer in an organic solvent,
(b) applying the cocktail to a first major surface of the glass fiber carrier substrate, and
(c) allowing the cocktail to dry, whereby a solid-state thin film coating is formed on the glass fiber carrier substrate to form the luminescent element.

21. The method of claim 20 wherein the cocktail is applied to the first major surface of the glass fiber carrier substrate by dipping the glass fiber carrier substrate into a supply of the cocktail.

22. The method of claim 20 wherein the cocktail comprises a solution of platinum-octaethylporphine-ketone and polystyrene in ethylacetate.

23. The method of claim 20 wherein the concentration of the polymer in organic solvent is in the range of 0.1 to 20% w/w and the dye:polymer ratio is in the range of 1:20 to 1:10,000 w/w.

24. A method of preparing a photoluminescent oxygen-sensitive probe comprising the steps of:
(a) preparing a luminescent element in accordance with claim 20, and
(b) laminating the luminescent element onto the first major surface of a structural support layer.
